(19) United States
(12) Patent Application Publication
(10) Pub. No.: US 2015/0308079 A1
(43) Pub. Date: Oct. 29, 2015

(54) A METHOD FOR RECOVERING ENERGY AND A HYDRAULIC SYSTEM

(71) Applicants: Bo VIGHOLM, Stora Sundby (SE); Andreas EKVALL, Hallstahammar (SE); Kim HEYBROEK, Kvicksund (SE)

(72) Inventors: Bo VIGHOLM, Stora Sundby (SE); Andreas EKVALL, Hallstahammar (SE); Kim HEYBROEK, Kvicksund (SE)

(73) Assignee: VOLVO CONSTRUCTION EQUIPMENT AB, Eskilstuna (SE)

(21) Appl. No.: 14/404,493

(22) PCT Filed: May 30, 2012
(86) PCT No.: PCT/SE2012/000084

§ 371 Date: May 27, 2015

(51) Int. Cl. E02F 9/22; G05D 16/20; B62D 5/07; G05B 15/02; E02F 9/08; B62D 12/00

(52) U.S. Cl. CPC E02F 9/2217; E02F 9/0866; B62D 12/00; B62D 5/075; E02F 9/2292; E02F 9/2296; G05B 15/02; G05D 16/2066

(57) ABSTRACT

A method is provided for recovering energy in a hydraulic system of a working machine. The hydraulic system includes at least one hydraulic cylinder for movement of a load, and a fan driven by a hydraulic motor. The file method includes pressurizing the hydraulic cylinder with a load pressure at one of the piston side and the piston rod side of the hydraulic cylinder for moving the load, the load pressure substantially exceeding a pressure difference between the piston side and the piston rod side of the hydraulic cylinder required to move the load, creating a counter pressure at the other of the piston side and piston rod side of the hydraulic cylinder, where the counter pressure is created by means of the hydraulic motor while the hydraulic motor is driven by a hydraulic return flow from the hydraulic cylinder, by creating the counter pressure by means of the hydraulic motor while the hydraulic motor is driven by a return flow of hydraulic fluid from the hydraulic cylinder, the counter pressure created by the hydraulic motor being a function of the magnitude of the return flow driving the hydraulic motor and the load on the hydraulic motor. Energy consumption of a vehicle can be reduced in a simple and cost-effective way.

### BACKGROUND AND SUMMARY

The present invention relates to a method for recovering energy in a hydraulic system of a working machine and to a hydraulic system for recovering energy in a working machine.

The invention is applicable on working machines within the fields of industrial construction machines, in particular wheel loaders and articulated haulers. Although the invention will be described with respect to a wheel loader, the invention is not restricted to this particular machine, but may also be used in other—working machines having hydraulic functions, such as dump trucks, excavators or other construction equipment.

A working machine is provided with a bucket, container or other type of implement for digging, lifting, carrying and/or transporting a load.

A wheel loader, for instance, has working functions driven by hydraulics, such as lifting and tilting of an implement arranged on a load arm unit. The load arm unit comprises a number of hydraulic cylinders for movement of the load arm and the implement attached to the load arm. A pair of hydraulic cylinders can be arranged for lifting the load arm and a further hydraulic cylinder can be arranged on the load arm for tilting the implement.

The wheel loader which usually is frame-steered has also a pair of hydraulic cylinders for turning/steering the wheel loader by pivoting a front part and a rear part of the wheel loader relative to each other.

In addition to the hydraulic cylinders, the hydraulic system of a wheel loader comprises one or more hydraulic machines (pumps) for providing hydraulic fluid to the hydraulic cylinders of the load arm unit and the steering unit.

The steering system may comprise a stabilizing system in order to stabilize the steering and to obtain a more rigid steering without twitches.

Such a steering stabilizing system usually comprises a pressure valve which creates a counter pressure in the hydraulic steering system. The pressure valve is comprised in the return line from the steering valve and can be set to a pressure value of e.g. 10-40 bars such that a counter pressure is created for the steering cylinders. This means that the steering pressure must be increased with the same pressure value, which in turn leads to a higher pressure drop and an increased energy loss. When only the steering function of the vehicle is used, the hydraulic main pump can be set to the steering pressure.

When a further hydraulic work function is used at the same time as the steering, the pressure from the hydraulic main pump is set to the pressure level of the subsystem requiring the highest pressure. This may e.g. be lift system, which may require a pressure of up to 200 bars or more. If the steering requires 50 bar at the same time, a pressure drop of 150 bars will take place over the steering system, which also leads to an increased energy loss.

One solution to this problem is to use separate hydraulic pumps for the steering system and the lift system. Such a solution is however costly and adds weight to the vehicle. Further, it requires larger installation space and the energy loss is higher for such a solution.

It is known to recover energy from e.g. lift and tilt cylinders having a high pressure and a large hydraulic fluid flow. Such an energy recovery system may either power a hydraulic motor or may charge an accumulator. In such a system, the energy from high pressures and/or large hydraulic flows can be recovered, but these systems are not suitable for lower pressures and/or lower fluid flows.

U.S. Pat. No. 6,151,894 describes a system that can recover flows of a hydraulic pressure fluid returned from a plurality of hydraulic actuators, which includes a plurality of fluid recovery circuits into which flows of a hydraulic pressure fluid returned from such a plurality of actuators are admitted, and a main fluid recovery circuit There is provided a selector means for permitting at least one of the plural fluid recovery circuits selectively to communicate with the main fluid recovery circuit. The system, by permitting at least one of a plurality of fluid recovery circuits to communicate with a main fluid recovery circuit, enables a hydraulic return pressure fluid from at least one of a plurality of actuators to be recovered and hence is applicable to a working machine involving a plurality of hydraulic actuators. In one embodiment, a cooling fan motor may be driven by the main fluid recovery circuit. A variable flow rate control valve may be arranged at the influent side of the cooling fan motor, which may be used to control the speed of rotation of the cooling fan. The excessive pressure, i.e. the excessive fluid, from the variable flow rate control valve is discharged to a fluid reservoir.

In this solution, only a part of the energy stored in the fluid system can be recovered. The recovered energy is depending on the rotational speed of the cooling fan. The pressure drop over a cooling fan motor is in normal conditions relatively low, with a maximum pressure drop at the highest permissible rotational speed. Further, the flow throughput of a hydraulic cooling tan is relatively low. This means that when a hydraulic motor adapted to drive the cooling, fan is used to recover energy, only part of the hydraulic flow is used since the excessive flow is discharged by the flow rate control valve. The efficiency of such a system is thus dependent on the used pressure in the vehicle. For a vehicle having e.g. a lift cylinder, which may be powered by a pressure of 200 bars and more and which also have a relatively large flow throughput, only a part of the hydra tic fluid flow will be used to drive the cooling fan.

There is thus a need for an improved energy recovery system.

It is desirable to provide an improved method for energy recovery in the hydraulic system of a vehicle. It is also desirable to provide an improved arrangement for energy recovery in a vehicle.

In a method for recovering energy in a hydraulic system of a working machine, the hydraulic system comprising at least one hydraulic cylinder for movement of a load, and a hill driven by a hydraulic motor, comprising the steps of pressurizing the hydraulic cylinder with a load pressure at one of the piston side and the piston rod side of the hydraulic cylinder for moving the load, the load pressure substantially exceeding a pressure difference between the piston side and the piston rod side of the hydraulic cylinder required to move the load and creating a counter pressure at the other of the piston side and piston rod side of the hydraulic cylinder, where the counter pressure is created by means of the hydraulic motor while the hydraulic motor is driven by a hydraulic return flow from the hydraulic cylinder, the counter pressure created by the hydraulic motor being a function of the magnitude of the return flow driving the hydraulic motor and the load on the hydraulic motor.

By this first embodiment of the method for energy recovery according to the invention, a method where a cooling fan motor is driven by the return fluid flow from a hydraulic cylinder is provided, where a counter pressure is created at the return port of the hydraulic cylinder control valve by the hydraulic cooling fan motor. The counter pressure created is dependent on the magnitude of the return flow driving the hydraulic motor and of the load on the hydraulic motor. By creating a counter pressure at the return port of the hydraulic cylinder, the system controlled by the hydraulic cylinder will be stiffer. At the same time, a higher pressure will be present at the return port of the control valve. This higher pressure would lead to a higher energy loss if it was discharged into a drainage reservoir. By using this pressure to power a cooling fan motor, the higher pressure can be recovered instead of being discharged. The higher pressure of the counter pressure will increase the possibility that there will be enough pressure and/or fluid flow to drive the cooling fan motor. The efficiency will thus be increased.

In an advantageous development of the inventive method, the created counter pressure is maintained at a predetermined first pressure level. The predetermined first pressure level may be a fixed pressure value that is always used for a specific work function, or the predetermined pressure level may be dependent on a specific condition on the vehicle. When the work function is the steering of the vehicle, the predetermined pressure level may be dependent of the steering angle and/or the steering velocity of the vehicle. The steering velocity corresponds to the flow velocity of the steering cylinders. With a higher steering velocity, a higher counter pressure is of advantage. The steering angle may be measured by a sensor.

In an advantageous development of the inventive method, the counter pressure is maintained at a second predefined pressure level by a controllable pressure valve set to a pressure level somewhat higher than the required counter pressure when the pressure of the hydraulic return flow is greater than the required counter pressure. The second predefined pressure level is higher than the first predefined pressure level. In one example, the second pressure level is at least 5 bars higher than the first predefined pressure level. In this way, the counter pressure can be maintained at a stable level also when the pressure of the return line is higher than the required pressure level. The controllable pressure valve is further of advantage since it protects the cooling fan motor from sudden pressure bursts that may occur in the hydraulic system.

In an advantageous development of the inventive method, the counter pressure is maintained at a required pressure level by adding an additional fluid flow, e.g. from a hydraulic pump, set to the required counter pressure level when the pressure of the hydraulic return flow is lower than the required counter pressure. In this way, the required counter pressure level can be maintained also when the fluid flow from the return flow is low. By adding a fluid flow from a hydraulic pump, most of the fluid flow from the return port can be preserved.

In an advantageous development of the inventive method, the required counter pressure may also be maintained at a pressure level that corresponds to the difference between the load pressure of a first work function and the load pressure of a second work function, in order to minimize the losses that occur when both functions are used at different pressure levels. The load pressure of the first work function, e.g. the steering of the vehicle, may be measured by a first pressure sensor, and the load pressure of the second work function, e.g. the lift system of the vehicle, may be measured by a second pressure sensor. The control unit calculates the difference and outputs a signal corresponding to the required counter pressure to a variable pressure device, such as a controllable hydraulic pump, which will output the required counter pressure level. By selecting a counter pressure for the steering function that is higher than normal, both the steering function and the lift system can be supplied with the same pressure level from the main hydraulic pump, which will minimize the pressure loss over the steering system.

In an advantageous development of the inventive method, the actual counter pressure is measured by a pressure sensor or is estimated by measuring the rotational speed of the cooling fan. By measuring a value corresponding to the actual counter pressure, the hydraulic pump used to supply an additional fluid flow in order to obtain the required counter pressure can be controlled in a reliable way and can be shut of when the pressure of the return port is high enough.

In a hydraulic system for recovering energy in a working machine, comprising at least one hydraulic cylinder for movement of a load, and a fun driven by a hydraulic motor, the hydraulic motor is connected to the hydraulic cylinder for receiving a return flow of hydraulic fluid from the hydraulic cylinder and creating a counter pressure in the hydraulic cylinder, the counter pressure created by the hydraulic motor being a function of the magnitude of the return flow driving the hydraulic motor and the load on the hydraulic motor.

By this first embodiment of the inventive hydraulic system, the energy of the return of a hydraulic, cylinder can be recovered. Since the pressure at the return port is higher in a system where a counter pressure is created at the return port, a higher degree of energy can be recovered with the inventive system. The return port is connected to a cooling fan motor such that the cooling fan is driven by the return flow of the hydraulic cylinder.

In an advantageous development of the inventive system, the hydraulic system comprises two work functions. One of the working functions is preferably a steering function of the vehicle, and the other work function may be a lift or a tilt function.

In an advantageous development of the inventive system, the hydraulic system further comprises a variable pressure valve adapted to maintain the counter pressure at a predefined second pressure value. The second predefined pressure level is higher than the first predefined pressure level, such that the pressure valve will only discard a fluid flow when the pressure is somewhat higher than the required counter pressure. Preferably, the second pressure value is at least 5 bars higher than the first pressure level.

In an advantageous development of the inventive system, the hydraulic system further comprises a controllable fan pump adapted to be set to the first predefined pressure value. In this way, the fan pump can be used to maintain the required counter pressure when the pressure of the fluid flow from the return port is not high enough. The controllable fan pump is set to the required pressure level and will output a fluid flow required to hold the counter pressure at the required pressure level. When the pressure of the fluid flow from the return port is high enough, the flow from the pump will be zero or close to zero. In this way, the pump will only supply a fluid flow when required.

In an advantageous development of the inventive system, the pressure in the first work function, e.g. the steering cylinders, is measured with a first pressure sensor and the pressure in the second work function, e.g. the lift system, is measured with a second pressure sensor. A control unit reads the signals from the first pressure sensor and the second pressure sensor and outputs a control signal to the controllable pressure device, i.e. the controllable fan pump, where the control signal corresponds to a pressure value that is the difference between the pressure in the steering cylinder and the pressure in the lift system. In this way, the counter pressure is adapted to the pressure of the main pump unit of the vehicle, which reduces the pressure loss over the steering system. In this way, the efficiency of the energy recovery system is enhanced.

### BRIEF DESCRIPTION OF DRAWINGS

The invention will be described in greater detail in the following, with reference to the attached drawings, in which

FIG. 1 shows a side view of a wheel loader having a bucket for loading operations,

FIG. 2 shows a known schematic hydraulic system used in a vehicle according to FIG. 1,

FIG. 3 shows a first example of a schematic hydraulic system according to the invention,

FIG. 4 shows a second example of a schematic hydraulic system according to the invention, and

FIG. 5 shows a schematic flow chart of an inventive method according to the invention.

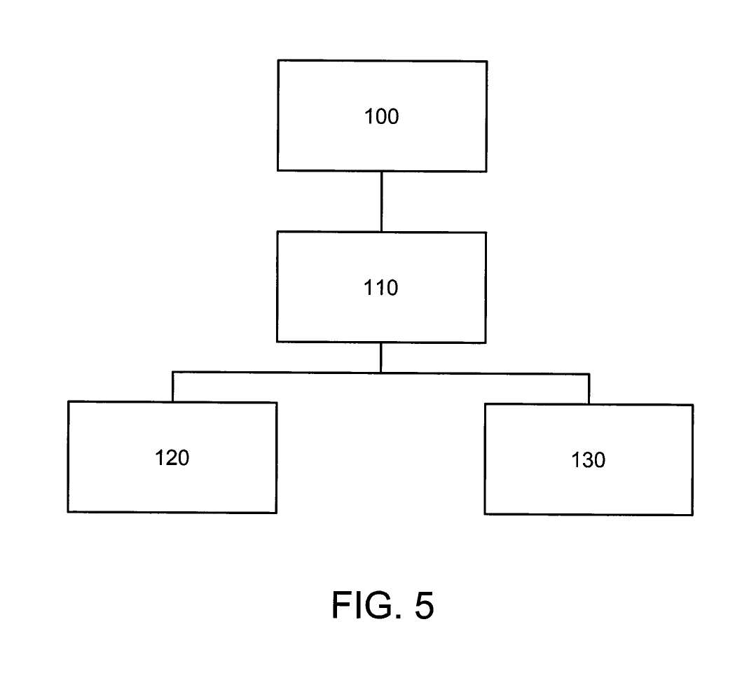

### DETAILED DESCRIPTION

The embodiments of the invention with further developments described in the following are to be regarded only as examples and are in no way to limit the scope of the protection provided by the patent claims.

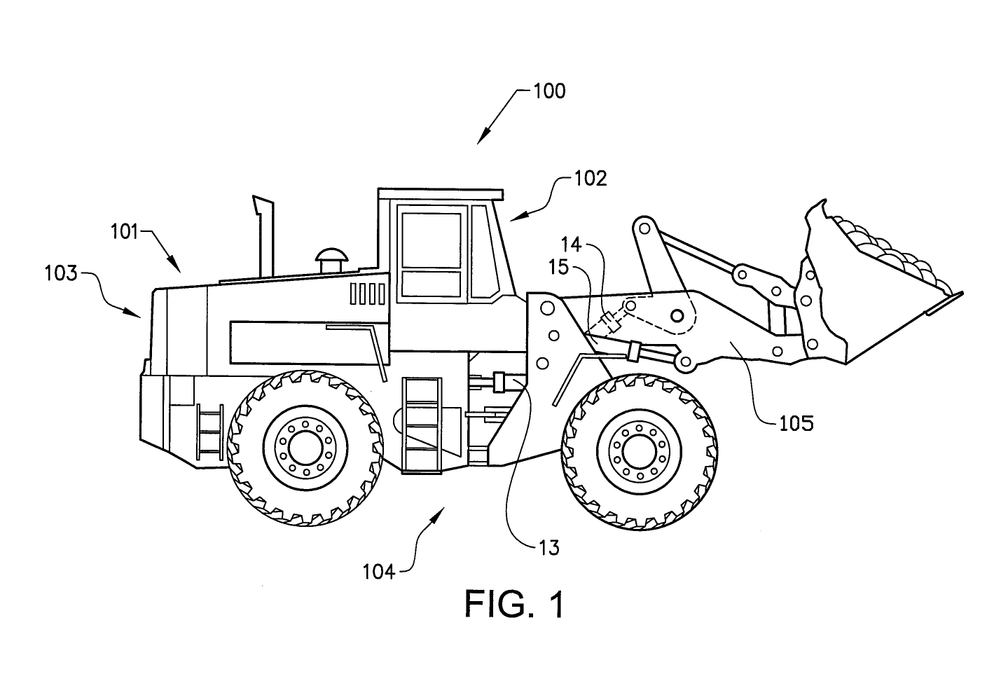

FIG. 1 is an illustration of a working machine 00 in the form of a wheel loader. The wheel loader comprises a bucket arranged on lift arms 105 for lifting and lowering the bucket and the bucket can further be tilted relative to the lift arms. The wheel loader 100 is provided with a hydraulic system 104 comprising at least one hydraulic machine (not shown in FIG. 1). The hydraulic machine or pump can be used for providing the hydraulic cylinders with hydraulic fluid, for example to lift and tilt the bucket and to steer to vehicle.

In the example embodiment illustrated in FIG. 1, the hydraulic system comprises two hydraulic lift cylinders 17 for the operation of the lift arms 105 and a hydraulic cylinder 14 for tilting the bucket. The hydraulic lift cylinders, the tilt cylinder and the hydraulic steering system are powered by a main hydraulic pump comprised in the hydraulic system of the vehicle. Furthermore the hydraulic system comprises a second hydraulic pump arranged to power a second hydraulic system. In the shown example, the second hydraulic pump is arranged to supply hydraulic fluid to a hydraulic motor for driving a cooling fan of the vehicle. The second hydraulic pump may also be arranged to supply oil to other hydraulic systems arranged on a vehicle, such as the hydraulic brake system and the like. The wheel loader farther comprises an engine compartment 101 having an engine with a radiator system 103 and a driver cab 102.

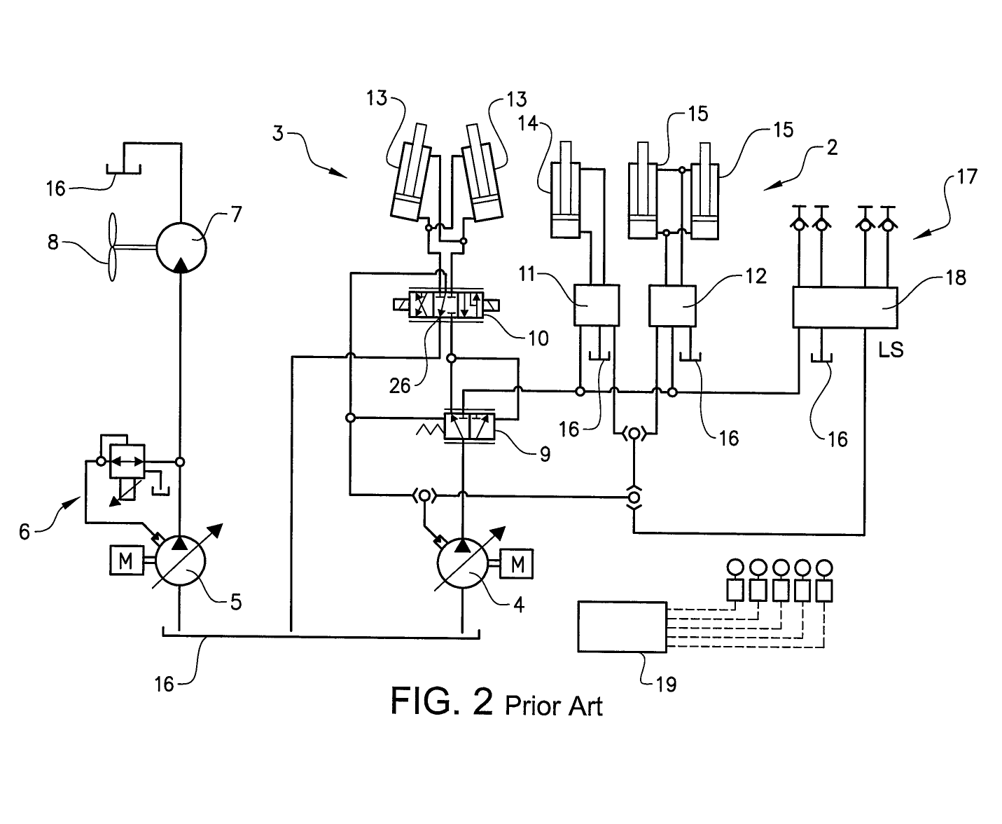

FIG. 2 shows schematically a part of a known hydraulic system used in a heavy vehicle. In the shown example, a wheel loader is used as an example of a heavy vehicle, but also other types of heavy vehicles are plausible. The hydraulic system comprises a lift and tilt arm hydraulic cylinder system 2 and a steering, system 3, a main hydraulic pump 4, a cooling fan pump 5 and a cooling, fan 8. The hydraulic system is controlled by an electronic control system 19 in a known manner.

The lift and tilt arm hydraulic cylinder system 2 comprises at least one lift cylinder 15, in the shown example two lift cylinders are used, controlled by a lift valve 12, and a tilt cylinder 14 controlled by a tilt valve 11, which are operated by an operator for lifting, lowering and tilting the bucket. The steering system 3 comprises at least one steering cylinder 13, in the shown example two steering cylinders are used, and a steering valve 10, which is operated by an operator for steering the vehicle. The hydraulic system 1 is powered by a variable main hydraulic pump 4. The fluid from the main hydraulic pump 4 is fed to the lift and tilt arm hydraulic cylinder system 2 and the steering system 3 through a prioritizing valve 9. The prioritizing valve 9 is arranged on the outlet conduit from the main hydraulic pump 4 and will automatically prioritize that the steering function receives the required pressure before the lift function and the tilt function.

The radiator cooling system of the vehicle comprises a cooling fan 8 attached to a cooling fan motor 7 which is powered by a hydraulic fluid, such as hydraulic oil. The hydraulic oil is supplied from a cooling fan pump 5 which is controlled by a pressure regulator valve 6. The pressure regulating valve 6 is controlled by an electrical signal from the control unit which can set the required output pressure from the pump, since the pump is provided with a variable displacement. In this way, the pump can be regulated to specific requirements. One such requirement is the temperature of the radiator circuit. The vehicle control system can send a signal to the pressure regulator valve such that the pump pressure is adapted to the radiator temperature. The speed of the radiator fan is thus controlled by the pump pressure. In this way, the pump must not supply more oil than necessary to the cooling fan motor 7, thereby preserving energy. It is also possible to control the flow of the cooling fan pump by setting the displacement of the pump, where the flow of the second hydraulic pump is controlled, by an electric displacement signal by the vehicle control system.

The hydraulic system may also comprise additional hydraulic work functions 17 controlled by a supplementary control valve 18. The return fluid from the hydraulic functions are drained to a drainage reservoir 16, where the return fluid is collected and recirculated by the main hydraulic pump and the cooling fan pump. The pressure drop over a component is lost when the hydraulic fluid is drained into the drainage reservoir. This energy loss depends on the actual pressure used by the system. When only the steering of the vehicle is used, the pressure loss may be in the region of 30-50 bar, when the lift cylinders are used, the pressure loss may be up to 200 bar and more.

In order to stabilize the steering of a vehicle being steered with hydraulic cylinders, it is advantageous to create a counter pressure at the return line of the steering. Such a counter pressure may be in the interval between 10 and 40 bars and will stiffen the steering. Normally, such a counter pressure is achieved by providing a pressure restriction valve set to the required pressure in the return line. The fluid from the pressure restriction valve is drained to the drainage reservoir. In the shown example, a pressure restriction valve could be inserted in the return line between the return port 26 and the drainage reservoir 16 in order to create a counter pressure.

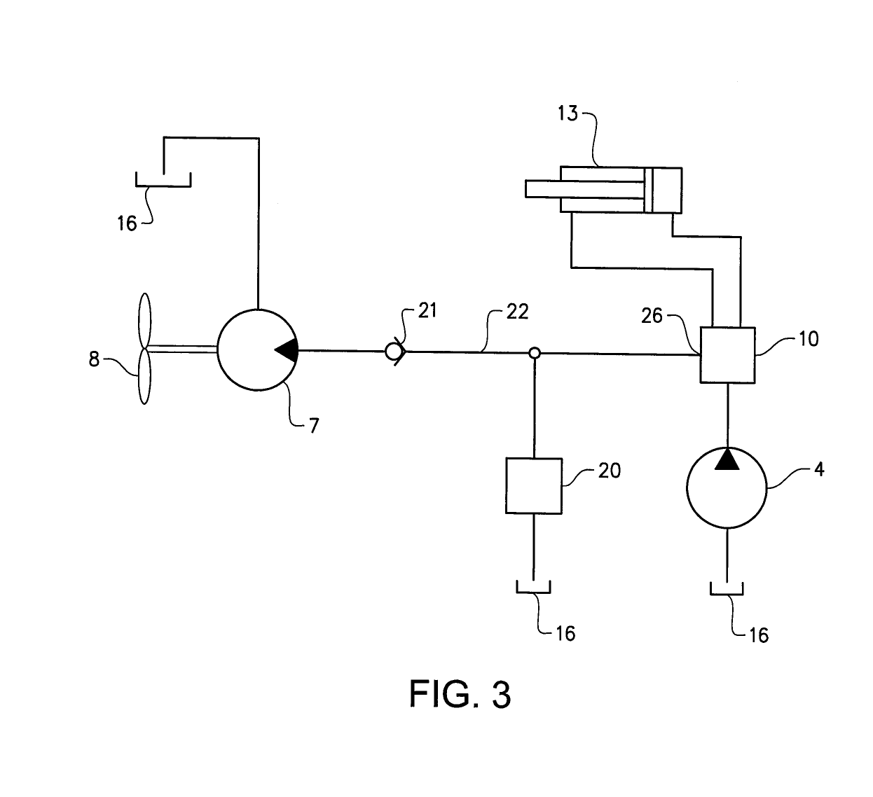

FIG. 3 shows a first example of a schematic inventive hydraulic system adapted for the use in a vehicle, such as a wheel loader or other heavy construction vehicle.

In the inventive system adapted for energy recovery, a hydraulic pump 4 is used to pressurize a steering cylinder 13 via a steering valve 10. The return port 26 of the steering valve is connected to a cooling fan motor 7 by a conduit 22. The cooling fan motor 7 is adapted to drive a cooling fan 8. The conduit 22 is provided with a check valve 21 which prevents fluid from flowing backwards, from the cooling fan pump to the return port 26 of the steering valve. The return port 26 is also connected to the drainage reservoir 16 through a variable pressure support valve 20. The support valve 20 is controlled by the control unit and can be set to a predetermined pressure level. When the pressure at the input of the support valve 20 is greater than the predetermined pressure level, the valve will bypass some of the fluid to the drainage reservoir. The fluid flow from the return port will thus drive the cooling fan motor.

The cooling fan motor is dimensioned such that it creates a required counter pressure at the return port at a predefined fluid flow. Such a counter pressure, i.e. pressure drop over the fan motor, may be 30 bars at a nominal pressure flow. In a normal steering condition, the counter pressure for the steering system will thus be 30 bars and the return flow from the steering valve is used to drive the cooling fan motor. The counter pressure created by the hydraulic cooling fan motor is dependent on the magnitude of the return flow to the hydraulic motor and also on the load on the hydraulic motor. The load of the motor may e.g. be altered by using a fan with tiltable fan blades which can be used to control of the motor.

If the return fluid flow from the steering valve is greater than the nominal fluid flow, the created counter pressure will be greater than the required value. The pressure support valve 20 is set to a value that is slightly greater than the required counter pressure value, in this example to 35 bars, such that excessive fluid flow can be conducted to the drainage reservoir. In this way, the required counter pressure can be maintained.

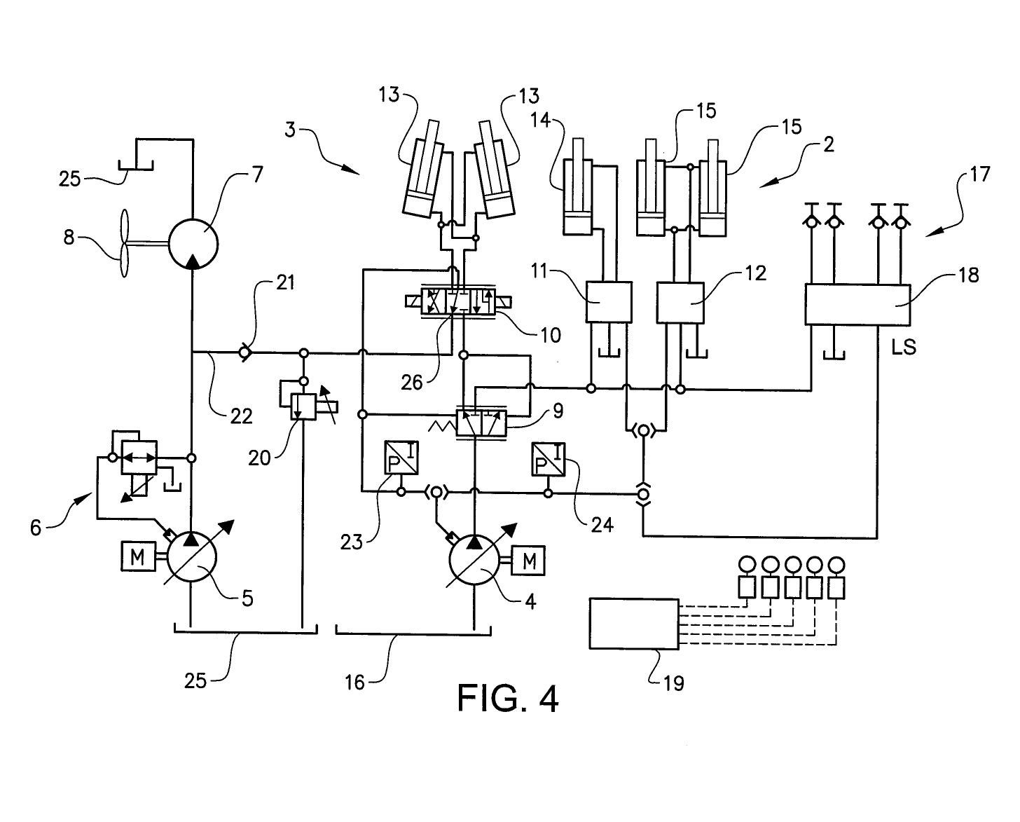

FIG. 4 shows a second example of an inventive hydraulic system adapted for the use in a vehicle, such as a wheel loader or other heavy construction vehicle. The same components as used in the system of FIG. 2 are denoted with the same reference numbers. In the shown system, the drainage reservoir comprises a first drainage reservoir 16 and a second drainage reservoir 25. In this way, it is possible to have separate drainage reservoirs on the front and the rear part of an articulated vehicle. The two drainage reservoirs may also be integrated as one or may be interconnected to each other with a compensation line.

In the inventive system adapted for energy recovery, a variable pressure support valve 20 is added in the return line from the return port 26 of the steering valve to the drainage reservoir. The support valve 20 is controlled by the control unit and can be set to a predetermined pressure level, When the pressure at the input of the support valve 20 is greater than the predetermined pressure level, the valve will bypass some of the fluid to the drainage reservoir. The inventive system further comprises a conduit 22 connecting the return port 26 of the steering valve to the cooling fan pump 7 and the cooling fan motor 5. The conduit 22 is provided with a check valve 21 which prevents fluid from flowing backwards, from the cooling the pump to the return port 26 of the steering valve. Further, the inventive system is provided with a first pressure sensor 23 adapted to measure the pressure in the steering system and a second pressure sensor 24 adapted to measure the pressure in the lift and tilt system.

The hydraulic cylinders are in the shown example arranged such that the cylinders are pressurized with the load pressure by the hydraulic motor 4 at the piston side of the hydraulic cylinders. The return flow from the hydraulic cylinders will thus flow from the piston rod side of the hydraulic cylinders. It is however also possible to arrange a hydraulic cylinder such that the hydraulic cylinder is pressurized at the piston rod side.

In one example of the inventive system, the system will recover energy from the steering system. In this example, the cooling fan motor is used to create the counter pressure for the steering stabilization. The cooling fan motor is thus selected such that it creates a required counter pressure at a predefined fluid flow. Such a counter pressure, i.e. pressure drop over the fan motor, may be 30 bars at a nominal pressure flow. In a normal steering condition, the counter pressure for the steering system will thus be 30 bars and the return flow from the steering valve is used to drive the cooling fan motor. In this example, only the steering of the vehicle is used.

If the return flow from the steering valve is less than the nominal fluid flow, the flow through the fan motor will not be high enough to create the required counter pressure. In this case, it is possible to allow a lower counter pressure or it is possible to set the pressure regulator valve 6 of the cooling fan pump 5 to supply an additional fluid flow such that the counter pressure at the cooling fan motor corresponds to the required counter pressure. The pressure regulator valve 6 is an electrically controlled, valve controlled, by the control unit and adapted to set a given pressure level for the cooling fan pump. The cooling fan pump is variable and will adapt the output flow from the pump such that the required pressure is obtained. In one example, the required counter pressure is 30 bars. The main hydraulic pump 4 will output the required pressure for the steering, which in this example is 50 bars. The return flow from the steering valve will flow through conduit 22 and will continue to flow through the cooling fan motor 7 and will thus power the cooling fan motor. If the return fluid flow from the steering valve is enough to create the required counter pressure, the cooling fan pump will adjust the output flow to almost zero since the required pressure is already present and will thus not supply any fluid.

If the fluid flow is smaller than the nominal fluid flow, such that the created counter pressure is less than 30 bars, the pressure regulator valve 6 can be set such that the cooling fan pump generates an additional fluid flow. Depending on the fluid flow from the return valve, this setting will create an additional fluid flow from the fan pump such that the counter pressure is 30 bars.

If the return fluid flow from the steering valve is greater than the nominal fluid flow, the created counter pressure will be greater than required. The pressure support valve 20 is set to a value that is slightly greater than the required counter pressure value, in this example to 35 bars, such that excessive fluid flow can be conducted to the drainage reservoir. In this way, the required created counter can be obtained. The cooling fan pump will not supply any fluid flow in this case and can be shut off.

In this way, the energy in the return line from t le steering system can be recovered in an easy way and can be used to power the cooling fan motor. The cooling fan pump may thus be dimensioned to a smaller size since most of the power to the cooling fan motor can be supplied from the return line of the steering.

It is also possible to use a controllable cooling fan motor connected to the return port of the steering valve. The pressure drop over the cooling fan motor and thus the required counter pressure can be set with an external signal from the control unit. Such a controllable fan motor may be arranged such that the controllable pressure drop can be controlled within a specified range, and may be set with a controllable fan coupling. It is also possible to use adjustable blades on the cooling fan. By tilting the blades, the resistance of the fan can be controlled, depending on the rotational speed of the fan. A required counter pressure for the steering stabilization can thus be obtained.

In a further example, both the steering system and the lift and/or tilt system is used simultaneously. In this case, the main hydraulic pump 4 will supply a pressure that is equal to the highest pressure required by any of the systems. Normally, the lift or tilt system requires the highest pressure, which may be up to 200 bars and more. In one example, the lift system requires 150 bars. This value is read by the pressure sensor 24. At the same time, the pressure required by the steering system is read by the pressure sensor 23, in this example the steering pressure value is 50 bars. The difference between the required pressure levels is thus 100 bars, which in a conventional system would give a pressure drop over the steering system of 100 bars which in turn would give an energy loss. In the inventive system, a counter pressure of around 100 bars is thus preferably created at the steering system return port 26. With the same cooling fan motor as described above, having a pressure drop of 30 bars at a nominal fluid flow, an additional fluid flow is required in order to obtain a counter pressure of 100 bars. The pressure regulator valve 6 of the cooling fan pump is thus set to 100 bars, such that the required counter pressure is obtained. The pressure loss over the steering system is thus reduced. The pressure support valve 20 is in this example also set to a slightly higher pressure value, e.g. 105 bars, in order to prevent sudden pressure bursts to reach the fan motor. If the pressure in the return line exceeds the required counter pressure, e.g. due to sudden pressure increases in the system, the pressure support valve 20 will bypass some of the excessive fluid to the drainage reservoir.

The required counter pressure can be dependent on e.g. the steering wheel ratio, i.e. the actual steering angle, or the steering velocity of the vehicle. The steering velocity corresponds to the flow velocity of the steering cylinders. With a higher steering velocity, a higher counter pressure is of advantage. The steering angle is measured at the steering wheel and is used to set the required counter pressure. The amount of fluid forwarded to the cooling fan motor from the return line may thus depend on the steering angle of the vehicle. If the steering angle is small, the counter pressure may be set to a relatively low value. If the counter pressure created by the fan motor is lower than the required counter pressure, i.e. the fluid flow through the cooling fan motor is lower than the nominal flow value, the cooling capacity will be reduced. In this case, the system may, instead of adding an additional flow from the fan pump, temporarily allow a higher temperature in the cooling system. The lost cooling capacity can be recovered when a higher fluid flow is available. In some cases, it may not be allowed to lower the cooling fan speed. In such a case, it is possible to let the cooling pump continue to deliver an additional fluid flow to the cooling fan motor in order to obtain the required counter pressure and thus the required cooling capacity.

If the pressure drop over the cooling fan motor, i.e. the pressure value set by the pressure regulator valve 6, is lower than the required counter pressure, the control unit may temporarily raise the pressure of the pressure regulator valve such that it matches the required counter pressure. This will cause the cooling fan motor to run faster than required, which will lower the temperature of the radiator circuit. When the steering has stopped, the cooling pump may be regulated to a lower pressure such that the temperature of the radiator circuit can resume the nominal temperature value.

If the return flow from the steering system is too high for the cooling fan motor, i.e. the rotational speed of the cooling fan motor would be higher than allowed, the pressure support valve 20 can be opened to drain of the excessive pressure to the drainage reservoir. It is thus of advantage to design the cooling fan motor such that it can handle the highest possible pressure from the return line in order to conserve as much energy as possible.

The actual counter pressure at the return port of the steering valve can be either estimated by using the nominal flow levels obtained from different input values, such as the steering, wheel ratio. The counter pressure can also be measured by a pressure sensor, or the rotational speed of the cooling fan can be used to obtain the fluid flow through the fan motor. The relation between the rotational speed and the pressure drop can be stored in a table.

The advantage of the inventive hydraulic system is that the cooling fan motor can be used for energy recovery. On an articulated construction vehicle, the steering is normally performed with steering, cylinders. For a wheel loader, the motor and the cooling system are positioned in the rear of the vehicle and the lift and tilt system is positioned at the front of the vehicle. By providing a separate energy conservation system in the back of the vehicle, the problem with hoses through the articulation is minimized, since no hose for the energy recovery must pass the articulation. With the cooling system and the steering valve in the back of the vehicle, the energy from the steering system can be recovered independently of the energy recovery system for the lift and tilt system. The vehicle may then be provided with separate drainage reservoirs, with a drainage reservoir 25 in the rear of the vehicle. On an articulated hauler, the engine and thus the cooling system and the steering system is mounted in the front part of the vehicle, with the lift cylinders in the rear part. Also for such a vehicle, separate energy recovery systems are of advantage.

FIG. 4 shows a schematic flow chart of a method for recovering energy in a hydraulic system of a working machine.

In step 100, a pressure for the work function is applied at an inlet port of the control valve unit controlling the work function, where the pressure exceeds the load pressure of the work function. By applying a pressure at the inlet port that is higher than the required load pressure for a specific work function, it is possible to create a counter pressure to the valve controlling the work function, which will make the work function stiffer since a counter pressure acts on the hydraulic cylinders.

In step 110, a counter pressure is created by a hydraulic motor at a return port of the control valve unit controlling the work function. With this counter pressure, the required load pressure will be provided over the hydraulic cylinders of the work function. A suitable work function to be used with a counter pressure is the steering of a vehicle. The counter pressure is created by a hydraulic cooling fan motor, where the pressure drop over the motor is selected such that a predefined counter pressure is obtained at a nominal, predefined fluid flow.

In step 120, the set pressure value for the cooling fan pump is set to the required counter pressure. By using a controllable pump, the fluid flow from the pump will adapt to the actual counter pressure at the cooling fan motor such that the required counter pressure will be maintained regardless of the fluid flow from the return port of the control valve. In this way, the return flow of the steeling system can be used to drive the cooling fan motor.

In step 130, the pressure exceeding the required counter pressure is released by a pressure support valve. The support valve is preferably set to a second predefined pressure level which is somewhat higher than the required counter pressure. In this way, a stable counter pressure can be maintained also when the pressure at the return port is higher than the required counter pressure. If the fluid flow from the return valve is larger than required to drive the cooling fan pump, it would also be possible to let the hydraulic cooling fan pump receive flow backwards through the pump, functioning as a hydraulic machine, and in this case let the pump function as a hydraulic motor. In this case, also the cooling fan pump will help recover energy and will in this case help to drive the engine of the working vehicle.

The invention is not to be regarded as being limited to the embodiments described above, a number of additional variants and modifications being possible within the scope of the subsequent patent claims.

### REFERENCE SIGNS

1: Hydraulic system

2: Lift and tilt arm hydraulic cylinder system

3: Steering system

4: Main hydraulic pump

5: Cooling fan pump

6: Pressure regulator valve

7: Cooling fan motor

8: Cooling fan

9: Prioritizing valve

10: Steering valve

11: Tilt valve

12: Lift valve

13: Steering cylinder

14: Tilt cylinder

15: Lift cylinder

16: Drainage reservoir

17: Additional hydraulic work functions

18: Supplementary control valve

19: Control unit

20: Pressure support valve

21: Check valve

22: Conduit

23: First pressure sensor

24: Second pressure sensor

25: Drainage reservoir

26: Return port

100 Vehicle

101 Engine compartment

102 Driver cab

103 Radiator system

104 Hydraulic system

105 Lift arm

1. A method for recovering energy in a hydraulic system of a working machine the hydraulic system comprising at least one hydraulic cylinder for movement of a load, and a fan driven by a hydraulic motor, comprising:
pressurizing the hydraulic cylinder with a load pressure at one of the piston side and the piston rod side of the hydraulic cylinder for moving the load, the load pressure substantially exceeding a pressure difference between the piston side and the piston rod side of the hydraulic cylinder required to move the load,
creating a counter pressure at the other of the piston side and piston rod side of the hydraulic cylinder,
creating the counter pressure by means of the hydraulic motor while the hydraulic motor is driven by a return flow of hydraulic fluid from the hydraulic cylinder, the counter pressure created by the hydraulic motor being, a function of the magnitude of the return flow driving the hydraulic motor and the load on the hydraulic motor and
obtaining a requisite counter pressure by: adding an additional flow of hydraulic fluid passing the hydraulic motor and or adjusting the blades of the cooling fan.

2. Method according to claim 1, the created counter pressure is maintained at a predetermined first pressure level.

3. Method according to claim 2, the predetermined first pressure level is selected based on the steering angle and/or the steering velocity of the working machine.

4. Method according to claim 1, the requisite counter pressure is maintained at a predefined first pressure level by adding a fluid flow from a hydraulic pump which is set to the requisite counter pressure level when the pressure of the hydraulic return flow is lower than the requisite counter pressure.

5. Method according to claim 1, comprising obtaining the requisite counter pressure by draining of a pad of the return flow of hydraulic fluid from the hydraulic cylinder not passing the hydraulic motor.

6. Method according to claim 5, the requisite counter pressure is maintained at a second predefined pressure level by draining off a part of the return flow by means of a controllable pressure valve which is set to a pressure level somewhat higher than the requisite counter pressure when the pressure of the hydraulic return flow is greater than the requisite counter pressure.

7. Method according to claim 1, the actual counter pressure is measured by a pressure sensor.

8. Method according to claim 1, the actual counter pressure is estimated by measuring the rotational speed of the cooling fan.

9. A hydraulic system for recovering energy in a working machine, comprising at least one hydraulic cylinder for movement of a load, and a fan driven by a hydraulic motor, the hydraulic motor is connected to the hydraulic cylinder for receiving a return flow of hydraulic fluid from the hydraulic cylinder and creating a counter pressure in the hydraulic cylinder, the counter pressure created by the hydraulic motor being a function of the magnitude of the return, flow driving the hydraulic motor and the load on the hydraulic motor, wherein the hydraulic system anther comprises a controllable fan pump adapted to be set to a first predefined pressure value and/or wherein the blades of the cooling fan are adjustable.

10. Hydraulic system according to claim 9, the hydraulic cylinder is controlled by a control valve unit and that the hydraulic motor is connected to a return port of the control valve unit.

11. Hydraulic system according to claim 9, the hydraulic system comprises at least two work functions having at least one hydraulic cylinder each.

12. Hydraulic system according to claim 11, a work function may be a steering function, a tilt function and/or a lift function.

13. Hydraulic system according to claim 9, the hydraulic system further comprises a variable pressure valve (20) adapted to maintain the counter pressure at a predefined second pressure value.

14. Hydraulic system according to claim 13, the predefined second pressure level is at least 5 bars higher than the first predefined pressure level.

15. Working machine, comprising a hydraulic energy recovery system according to claim 9.

16. Working machine according to claim 15, where the working machine is an articulated vehicle where an engine with a cooling system and the steering cylinders are arranged in one part of the vehicle and the lift and/or tilt system is arranged in the other part of the vehicle, the hydraulic recovery system is arranged in the same part of the vehicle as the engine.

17. A computer programmed for performing all the steps of claim 1 when the program is run on the computer.

18. A non-transitory computer program product comprising program code for performing all the steps of claim 1 when the program product is run on a computer.
